(19) United States
(12) Patent Application Publication
(10) Pub. No.: US 2003/0042655 A1
(43) Pub. Date: Mar. 6, 2003

(54) Modular forming tracks

(76) Inventor: Noman F. Kane, Fenton, MI (US)

Correspondence Address: CARLSON, GASKEY & OLDS, P.C., 400 WEST MAPLE ROAD, SUITE 350, BIRMINGHAM, MI, 48009, US

(21) Appl. No.: 09/941,542

(22) Filed: Aug. 29, 2001

(51) Int. Cl. B29C 53/08; B29C 71/00; B29C 71/02

(52) U.S. Cl. 264/322; 264/339; 264/345; 264/348; 425/403; 425/392

(57) ABSTRACT

A forming track forms flexible plastic tubing which carries fuel from a fuel tank to an engine into a desired shape. The forming track includes a curved channel to receive a round tubing and a pair of opposing flanges to secure the tubing in the forming track. The tubing slightly deforms between the pair of opposing flanges as the plastic tubing is positioned in the channel. After the tubing is inserted, the opposing flanges secure the tubing in the forming track. While positioned in the forming track, the tubing is set by heating and rapid cooling, thermosetting the tube into the shape of the forming track.

### BACKGROUND OF THE INVENTION

The present invention relates generally to a modular forming track with a curved inner surface and opposing retaining flanges which forms flexible plastic tubing to a desired shape for thermosetting.

Plastic tubing in a vehicle carries fuel from the fuel tank to an engine. The plastic tubing is commonly formed into a desired shape by positioning the tubing into a track including a square channel. The prior art track is commonly machined and includes fingers to retain the round tubing in the square channel. The plastic tubing is heated and then rapidly quenched to set the round tube into the desired shape.

There are several drawbacks to the prior art square channel track. For one, the machining operation is expensive. Additionally, as the channel is square, the round tubing only contacts the channel at three contact points, each of the sides and at the bottom. The three contact points provide minimal support for the tubing during setting. Finally, the fingers on the prior art track scar the outside of the tubing, leaving a mark on the tubing.

Hence, there is a need in the art for an improved modular forming track which forms plastic tubing to a desired shape for thermosetting which provides additional support for the tubing and does not scare the tubing.

### SUMMARY OF THE INVENTION

The present invention relates generally to a modular forming track which forms plastic tubing to a desired shape for thermosetting.

Flexible plastic tubing which carries fuel from a fuel tank to an engine in a vehicle is thermoset into a desired shape in a modular forming track. The forming track is stamped to form a curved channel and a pair of opposing flared flanges. Preferably, the forming track is stamped from a low carbon 14 gage steel (0.078″ ref.). Straight portions and curved portions may be welded together to create a forming track of a desired shape. The diameter of the curved channel of the forming track is variable by the stamping operation for use with tubings of different diameters.

As the distance between the opposing flanges is slightly less than the diameter of the tubing, the tubing slightly deforms while entering the curved channel. Once the tubing is positioned in the forming track, the opposing flanges retain the tubing in the curved channel. As the channel of the forming track is curved, approximately 180° of the tubing contacts the forming track.

The tubing is set in the forming tracks into a desired shape by thermosetting. While positioned in the forming track, the tubing is heated to a temperature between 275° F. and 300° F., allowing for the molecular structure of the plastic tubing to change. The tubing is then quenched by rapidly cooling the tubing to a temperature of 50° F., setting the tubing into the desired shape. As the cooling process slightly shrinks the tubing, the tubing can be easily removed from the forming track between the opposing flanges without deformation. The forming track can be cut and re-welded to make a forming track of a different shape for thermosetting.

Accordingly, the present invention provides a forming modular track which forms plastic tubing to a desired shape.

### BRIEF DESCRIPTION OF THE DRAWINGS

The various features and advantages of the invention will become apparent to those skilled in the art from the following detailed description of the currently preferred embodiment. The drawings that accompany the detailed description can be briefly described as follows:

FIG. 1 illustrates a schematic diagram of a fuel system of a vehicle;

FIG. 2 illustrates a cross-sectional view of the prior art forming mold having a square channel;

FIG. 3 illustrates a perspective view of a straight portion of the forming track of the present invention used to form the plastic tubing into the desired shape;

FIG. 4A illustrates a cross-sectional view of the forming track of the present invention with a plastic tube being inserted in the track and the tubing slightly deformed;

FIG. 4B illustrates a cross-sectional view of the forming track of the present invention with a plastic tube positioned in the channel;

FIG. 5 illustrates a curved portion of the forming tube used to form a bend in the plastic tube;

FIG. 6 illustrates a forming track made of welding straight portions and curved portions; and

FIG. 7 illustrates a cross-sectional view of the forming track of the present invention with the plastic tube being removed from the forming track;

### DETAILED DESCRIPTION OF THE PREFERRED EMBODIMENT

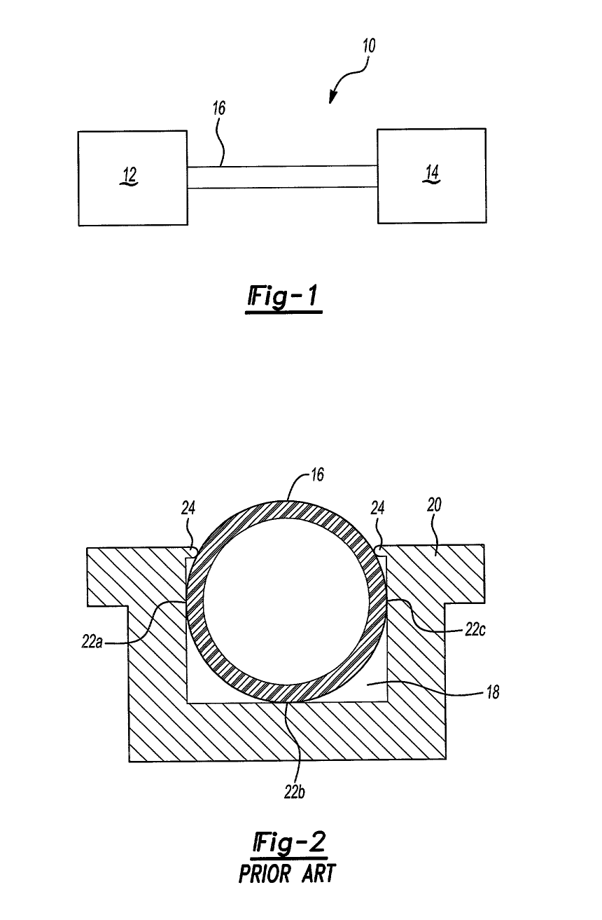

Now referring to FIG. 1, a schematic diagram of a fuel system 10 of a vehicle is illustrated. Fuel in a fuel tank 12 travels to the engine 14 through plastic tubing 16 thermoset into a desired shape. In the prior art, as shown in FIG. 2, the flexible plastic tubing 16 is set into a desired shape by heating and rapidly quenching the tubing 16 positioned in a square shaped channel 18 of a machined forming mold 20. As the channel 18 is square, the round tubing 16 contacts the channel 18 at three points of contact 22A, 22B and 22C. Fingers 24 are machined into the forming mold 20 to retain the tubing 16 in the channel 18 during thermosetting.

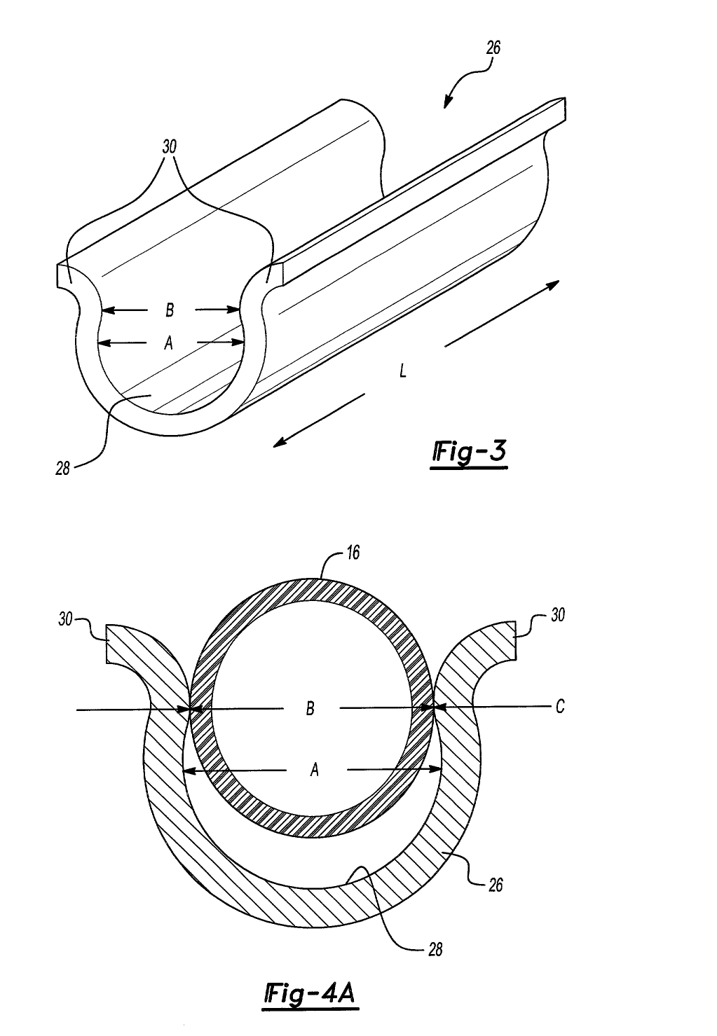

A straight portion of forming track 26 of the present invention is illustrated in FIG. 3. Preferably, the forming track 26 is stamped from a low carbon 14 gage steel (0.078″ ref.). The forming track 26 of length L is stamped to form a curved channel 28 having an inner dimension A. The inner dimension A is of sufficient size to receive the tubing 16 having diameter D and can be varied by the stamping operation for use with tubing 16 of different diameters D. Preferably, the forming track 26 includes a pair of opposing flanges 30 separated by a distance B which are formed by a second stamping operation.

As shown in FIG. 4A, the tubing is slightly deformable to a diameter C to allow entry of the tubing 16 through the opposing flanges separated by distance B, the distance C being approximately equal to but slightly smaller than the distance B of the opposing flanges 30. Once the tubing 16 is positioned in the channel 28, as shown in FIG. 4B, the tubing 16 expands to diameter D. As the distance B is less than the diameter D of the tubing 16, the tubing 16 is secured within the curved channel 28. As the channel 28 of the forming track 26 is curved, approximately 180° of the tubing 16 contacts the forming track 26.

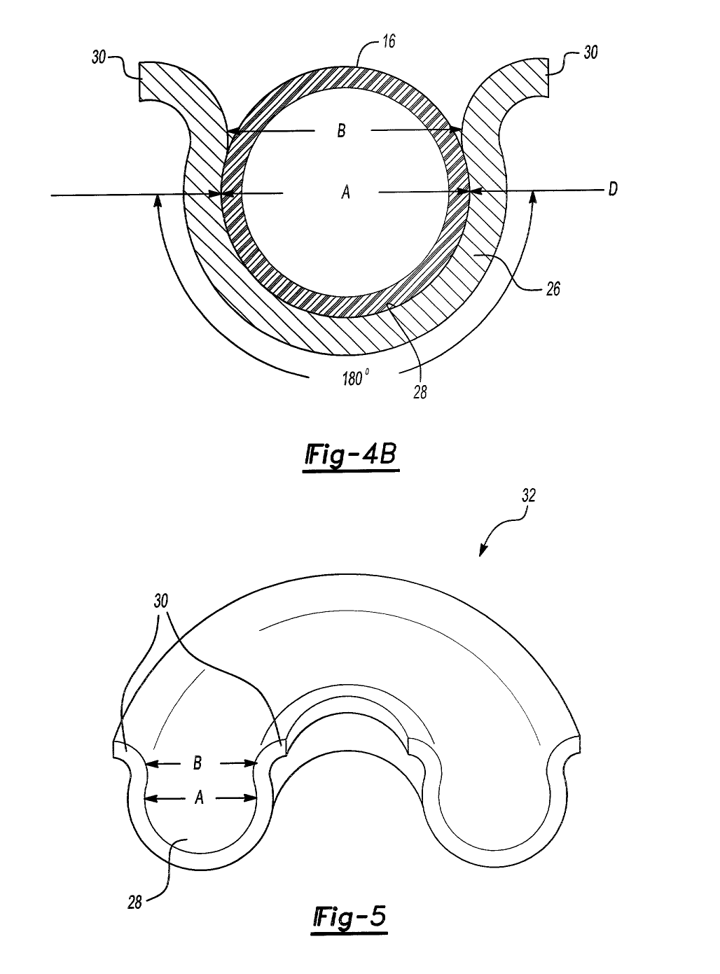

A curved portion of forming track 32 is stamped into a desired curvature to provide bends in the tubing 16, as shown in FIG. 5. The curved portion 32 also include a curved channel 28 stamped to have an inner dimension size A and a pair of flanges 30 separated by distance B. The curved portion 32 is shaped to any length and degree of curvature.

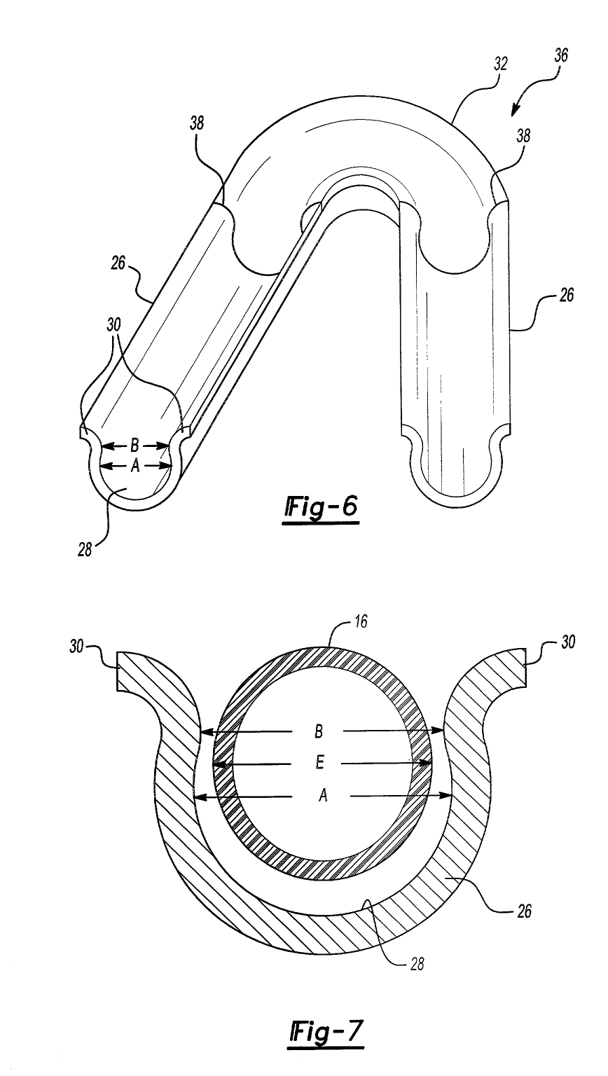

As shown in FIG. 6, straight tracks 26 and curved tracks 32 are welded together at welding points 38 to create a modular forming track 36 of a desired shape.

Once the plastic tubing 16 is secured in the forming track 36 by flanges 30, the tubing 16 is thermoset to retain the shape of the forming track 36. While positioned in the forming track 36, the tubing 16 is heated. Preferably, the tubing 16 is heated to a temperature of between 275° F. and 300° F. The tubing 16 is then quenched by rapidly cooling, preferably to a temperature of 50° F. The sudden change from a higher temperature to a lower temperature bonds the molecules of the plastic tubing 16, stiffening and thermosetting the tubing 16 into the shape of the forming track 36.

After setting, the tubing 16 is removed from the forming track 36. As shown in FIG. 7, the cooling process slightly shrinks the tubing 16 to diameter E. As diameter E is slightly less than the distance B of the flanges 30, the tubing 16 easily passes through the flanges 30 without deformation.

After thermosetting the tubing 16 to a desired shape, the forming track 36 can be cut and re-welded to create a forming track 36 of a different shape.

The stamped forming track 36 is less expensive to manufacture than the machined forming mold 20 of the prior art. Once the stamping dies are manufactured, additional tracks 26 and 32 can be quickly and accurately stamped. The interior dimension A of the tracks 26 and 32 can also be easily changed for use with tubings 16 of different diameters D. As the channel 28 is curved, there is approximately 180° of contact between the curved channel 28 and the tubing 16, allowing for more support during thermosetting. The forming track 36 of the present invention is durable and less prone to damage. As the tubing 16 is “snap fit” into the forming track 36, the fingers 24 of the prior art forming mold 20 are not needed to secure the tubing 16 in the curved channel 28, eliminating the formation of scars on the surface of the tubing 16.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specially described. For that reason the following claims should be studied to determine the true scope and content of this invention.

What is claimed is:

1. A track assembly for setting a tubing comprising:
a channel having a curved cross-section; and
a tubing inserted into said channel.

2. The track assembly as recited in claim 1 wherein said track assembly further includes a securing feature to secure said tubing in said channel.

3. The track assembly as recited in claim 1 wherein said tubing has a non-flexed diameter larger than a dimension of said securing feature and a flexed dimension approximately equal to said dimension of said securing feature.

4. The track assembly as recited in claim 3 wherein said tubing has said flexed dimension when said tubing is passing through said securing feature and said non-flexed dimension before and after said tubing is positioned into said channel.

5. The track assembly as recited in claim 1 wherein said securing feature is a pair of opposing flanges curved in opposing directions.

6. The track assembly as recited in claim 1 said channel has an interior dimension substantially equal to a non-flexed diameter of said tubing.

7. The track assembly as recited in claim 1 wherein said channel is curved such that said curved channel contacts approximately 180° of said tubing.

8. The track assembly as recited in claim 1 wherein said track assembly is stamped.

9. The track assembly as recited in claim 1 wherein said track assembly includes at least one straight track and at least one curved track, said tracks being welded together to form said track assembly.

10. A track assembly for setting a tubing comprising:
a channel having a curved cross-section and an interior dimension; and
a securing feature to secure said tubing in said curved channel,; and
said tubing having a diameter substantially equal to said interior dimension of said channel, said tubing being set by heating and rapid quenching.

11. The track assembly as recited in claim 10 wherein said track portion includes at least one straight track and at least one curved track, said tracks being welded together to form said track assembly.

12. The track assembly as recited in claim 10 wherein said tubing has a non-flexed diameter larger than a dimension of said securing feature and a flexed dimension approximately equal to said dimension of said securing feature, said tubing having said flexed dimension when said tubing is passing through said securing feature and said non-flexed dimension before and after said tubing is positioned into said channel.

13. The track assembly as recited in claim 10 wherein said securing feature is a pair of opposing flanges curved in opposing directions.

14. The track assembly as recited in claim 10 wherein said channel is curved such that said curved channel contacts approximately 180° of said tubing.

15. A method for setting a tubing comprising the step of:
forming at least one track portion including a channel having a curved cross-section.

16. The method as recited in claim 15 further comprising the step of forming a securing feature.

17. The method as recited in claim 15 further comprising the step of welding said at least one track portion together.

18. The method as recited in claim 15 further comprising the step of inserting said tubing into said curved channel.

19. The method as recited in claim 15 further comprising the steps of heating and rapidly quenching said tubing.

20. The method as recited in claim 18 wherein the step of inserting said tubing into said curved channel includes deforming said tubing to a flexed dimension approximately equal to a dimension of said securing feature and expanding said tubing to a non-flexed dimension greater than said dimension of said securing feature.

21. The method as recited in claim 15 wherein said curved channel is curved such that said curved channel contacts approximately 180° of said tubing.

22. The method as recited in claim 19 wherein the step of heating said tubing includes heating said tubing to a temperature between 275° F. and 300° F.

23. The method as recited in claim 19 wherein the step rapidly quenching said tubing includes quenching said tubing to a temperature of 50° F.

24. The method as recited in claim 15 wherein said at least one track portion if formed by stamping.
